(19) United States
(12) Patent Application Publication
(10) Pub. No.: US 2006/0092963 A1
(43) Pub. Date: May 4, 2006

(54) Architecture and method for efficient application of QoS in a WLAN

(76) Inventors: Ajay Bakre, Bangalore (IN); Hani Elgebaly, Beaverton, OR (US); Lakshmi Ramachandran, Bangalore (IN); Rajeev Muralidhar, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/977,967

(22) Filed: Oct. 28, 2004

(51) Int. Cl. H04J 3/22; H04J 3/16; H04B 7/00

(52) U.S. Cl. 370/437; 370/465; 370/310

(57) ABSTRACT

Architecture and method for quality of service (QoS) for multimedia and voice over Internet protocol (VoIP) applications in a wireless network, for example, a wireless local area network (WLAN). A QoS agent may be provided for a WLAN client to provide traffic profiles, parameters, and/or configuration settings to describe how an application may be executed with a desired QoS. A QoS agent may provide implementation of certain parameters and/or configurations to establish a data path that will provide a QoS for a traffic flow generated by a QoS application.

### FIELD

Embodiments of the invention relate to wireless networks, and particularly to standards—based extensions for performing quality of service functions for a wireless local area network client.

### BACKGROUND

In a wireless infrastructure, a wireless mobile station may be associated with a wireless access point (WAP) within a basic service set (BSS). Existing standards specifications do not provide a sufficient architecture (e.g., mechanisms and information) for providing specific quality of service (QoS) features to implement some high priority, high QoS applications, for example, voice over Internet Protocol (VoIP), multimedia, video, etc. The gaps in the architectures defined in some specifications may widen when attempts are made to implement these applications in particular environments, for example, an enterprise wireless local area network (WLAN).

### BRIEF DESCRIPTION OF THE DRAWINGS

The description includes various illustrations in the figures and accompanying drawings. These figures and accompanying details and descriptions are to be understood by way of example, and not by way of limitation.

FIG. 1 is an embodiment of a block diagram of a system in communication with an access point.

FIG. 2 is an embodiment of a block diagram of a client having a QoS API and a mapping module in communication with an access point.

FIG. 3 is an embodiment of a block diagram of a QoS API.

FIG. 4 is an embodiment of a block diagram of a mapping module.

FIG. 5 is an embodiment of a block diagram of a media access controller.

FIG. 6 is an embodiment of a block diagram of a client device.

FIG. 7 is an embodiment of a flow diagram of establishing QoS traffic in a WLAN.

FIG. 8 is an embodiment of a block diagram of layers of a QoS data flow stack.

FIG. 9 is an embodiment of a block diagram of a client device having a QoS agent.

### DETAILED DESCRIPTION

A wireless local area network (WLAN) architecture, such as that defined in the Institute of Electrical and Electronics Engineers (IEEE) 802.11* specifications, may fail to provide specific recommendations or best practices for employing quality of service (QoS) features for implementing voice over Internet Protocol (VoIP), multimedia, video, etc., applications. This may particularly be true when referring to enterprise WLAN environments. Therefore, support for such applications may be missing in many devices when used in such environments. Alternatively, proprietary implementations may be attempted, which may not provide standards—based interoperability. The (*) represents a variable, and may refer to any of a number of wireless IEEE specifications prefaced by 802.11, for example, 802.11e, 802.11i, 802.11k, etc. IEEE 802.11e corresponds to IEEE Draft Std. 802.11e relating to wireless medium access control (MAC) extensions for quality of service (QoS), draft in October 2004 and related documents/revisions. IEEE 802.11i corresponds to IEEE Std. 802.11i relating to wireless MAC extensions for enhanced security, approved July 2004 and related documents/revision. IEEE 802.k corresponds to IEEE Draft Std. 802.11k relating to radio resource measurements, draft in October 2004 and related documents/revisions.

Various references herein to an “embodiment” are to be understood as describing a particular feature, structure, or characteristic included in at least one embodiment of the invention. Thus, the appearance of phrases such as “in one embodiment,” or “in alternate an embodiment” may describe various embodiments of the invention, and may not necessarily all refer to the same embodiment.

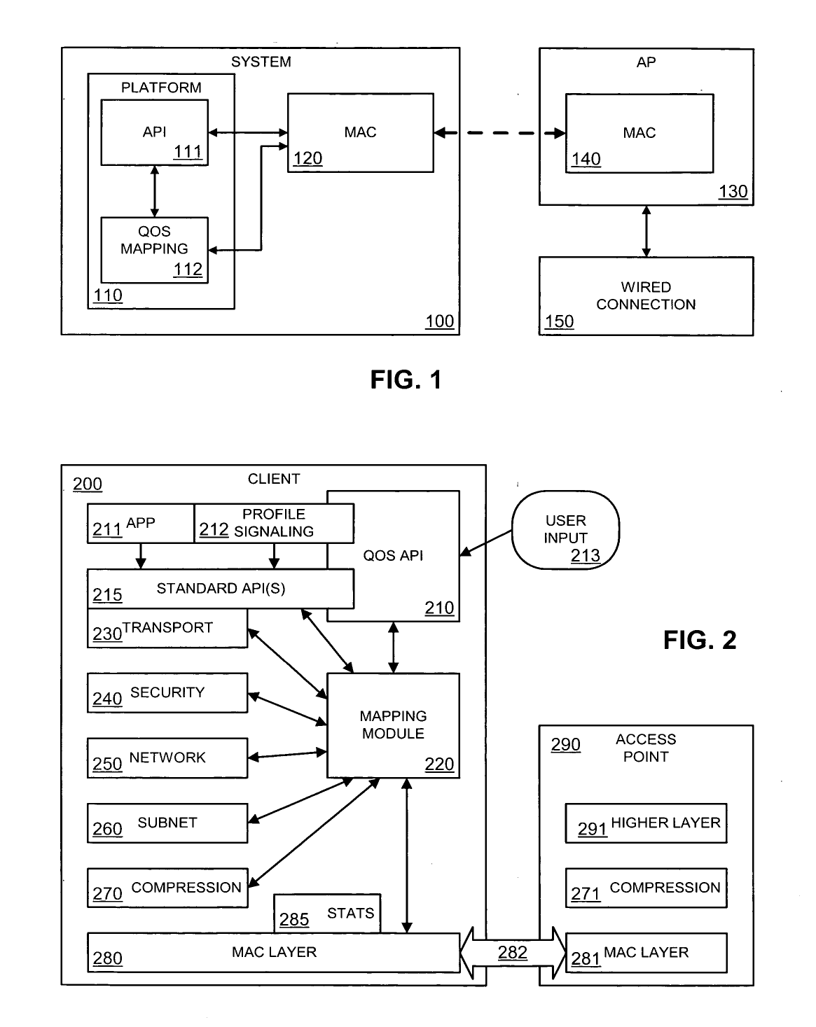

FIG. 1 is an embodiment of a block diagram of a system in communication with an access point. System 100 may represent a variety of electronic systems, apparatuses, or devices, for example, a personal computer (desktop, laptop, palmtop), a handheld computing device, personal digital assistant (PDA), wireless computing device, or other device with a wireless communication interface. Platform 110 on system 100 may include a hardware and/or software environment/container/platform on which to execute machine-readable instructions. Thus, platform 110 may include a processing core, memory, control logic, a microcontroller, a machine interface, a user interface, an operating system (e.g., Microsoft Windows®, Open BSD, Linux, etc.), a software application, driver, etc. Platform 110 may have one or more applications running or being executed.

In one embodiment application program interface (API) 111 may be present on platform 110. API 111 may represent an interface based on, derived from, etc., a standard, for example, a communication protocol. API 111 may also represent an interface that provides extensions to a known standard. An application running on platform 110 may generate quality of service (QoS) traffic and pass the traffic to a network interface via API 111. As discussed herein, QoS traffic represents a broad range of data, traffic, communications, etc, for example, traffic that has restrictions, limitations, and/or requirements on traffic flow, for example, bounds on jitter, delay, packet loss, etc. A bound, or a threshold, may represent a quality of traffic flow below which the traffic flow degrades, producing human-perceptible defects. In one embodiment a quality of traffic flow below a threshold represents an unacceptable quality of service. Traffic flow may be restricted if the quality is below a threshold, or range of acceptable quality.

QoS traffic may include voice over Internet Protocol (IP) (VoIP) traffic, multimedia streams, video streams, etc. An application running on platform 110 may be aware of the QoS expectations of a particular type of traffic associated with the application, or program. In one embodiment one or more profiles may be defined for various traffic types. A profile may include data/information about the QoS for the associated traffic. An application on platform 110 may interface with API 111 to pass a profile to QoS mapping 112. QoS mapping 112 represents a module, a subroutine, a linked library, a function call, etc., to provide an implementation of a profile or management/control to direct implementation of a profile. For example, API 111 may pass a profile to QoS mapping 112, which may determine from the profile a setting, configuration parameter, etc., for a layer of the data flow in system 100 to achieve the QoS defined in the profile. Thus, QoS mapping 112 may indicate a configuration, for example, to media access control/controller (MAC) 120, with which to handle the traffic flow corresponding to the profile. MAC 120 or another layer handles or operates on a traffic flow by any action related to the flow of data packets associated with the flow, e.g., preparing the data packets (for ingress or egress), decodes/encodes the data packets, forwards/routes the data packets, examines/snoops the data packets, reads a header of the data packets, etc.

In one embodiment system 100 includes MAC 120, which may represent hardware, firmware, and/or software to control an interface medium. MAC 120 may represent one or more components of a network interface card (NIC), a network port, a card connector (e.g., a personal computer/computing (PC) card), etc. MAC 120 may include configurable parameters, for example: hardware, software, and/or a combination. In one embodiment QoS mapping 112 receives a profile for a traffic flow from API 111 and translates the profile into one or more relevant parameters that may be implemented at one or various layers of a data path of the traffic flow. Translating the profile may include determining what parameters will affect traffic associated with the profile, looking up a profile and accessing/obtaining parameters associated with the profile, querying the application and/or a memory location for a profile match and/or a parameter to use for the profile, etc. This may involve the use of a table, e.g., a look-up table, a data structure in memory, etc. A parameter may be considered relevant if it affects or could affect the way in which a layer in the data path receives and/or operates on a data packet associated with the data flow. Examples of layers will be further discussed below.

MAC 120 may also gather/maintain statistics related to the quality of service given to a data flow. These statistics may be utilized for particular functions at MAC 120, and/or at layers of the data path. Thus, MAC 120 may indicate one or more statistics back to QoS mapping 112 and/or API 111. The statistics may be further passed up the data path to a software agent/module/subroutine, including one that may be part of an application seeking to establish the QoS data flow. An application and/or a function of the application may utilize the statistics to determine admission control and/or prioritization of a traffic associated with the flow.

In one embodiment system 100 maintains/has access to/utilizes a wireless connection with MAC 120. For example, MAC 120 may provide an interface for a wireless link/communication that complies with and/or is derived from an Institute of Electrical and Electronics Engineers (IEEE) 802.1x specification. For example, the IEEE 802.11 and IEEE 802.11e specifications define standards for wireless communication. Thus, MAC 120 may interface system 100 with a wireless local area network (WLAN). Through MAC 120, system 100 may be a client in such a WLAN. In one embodiment MAC 120 represents a media controller circuit and/or driver that executes the functionality defined in an IEEE standard specification and provides additional functionality. Thus, MAC 120 may include extensions not present in the standard specification.

One or more systems/devices may be clients associated with an access point (AP) in a WLAN. AP 130 represents a wireless access point. AP 130 includes MAC 140, which may be similar to MAC 120. In one embodiment both MAC 120 and MAC 140 include features of a standard communication protocol, and further support extensions of the communication protocol. A protocol extension may refer to one or more additional features, a feature modification, a modified and/or additional functionality, etc. Thus, a protocol extension may offer greater flexibility to a device implementing the protocol as compared to a device not enabled to support the extension. In one embodiment MAC 120 and MAC 140 support a wireless communication protocol that may offer prioritization of traffic flows, and support a protocol extension to provide admission control and/or greater flexibility in prioritization handling in the protocol layers. Thus, MAC 120 and MAC 140 may provide a QoS to a traffic flow that has tighter bounds on traffic control than specified in a standard protocol, may offer more control over which streams may be granted priority access, or may provide another function to enable MAC 120 and MAC 140 to offer multimedia, VoIP, and/or video traffic stream support.

AP 130 may interface with a wired, or landline, connection. Wired connection 150 may represent a bridge to a wide area network (WAN), which connectivity is offered to system 100 through the WLAN link. Wired connection 150 may thus include one or more of the following: a router, a switch, an IP domain, a Multi Protocol Label Switching (MPLS) domain, a Differentiated Services Code Point (DSCP) domain, the Internet, an enterprise network, Distribution System, etc. In one embodiment a profile of a traffic flow may include a marking/tag that may be recognized at wired connection 150 to provide a specific treatment of data packets associated with the data flow. For example, wired connection 150 may recognize priority packets, e.g., through a DSCP marking in the packet. In this way a traffic flow to be terminated outside a basic service set (BSS) may be provided with proper priority/QoS handling by each node along the entire path between the generating and terminating devices.

FIG. 2 is an embodiment of a block diagram of a client having a QoS API and a mapping module in communication with an access point. Client 200 represents a device, system, apparatus, etc., that may include a computing device, laptop computer, handheld, PDA, integrated computing/wireless device, etc. Client 200 may represent the device and/or the platform, either hardware, software, or a combination, on which various functions may be executed. In one embodiment client 200 may illustrate layers of a data path and/or a control path of a data flow. The elements of FIG. 2 may represent an architecture, a container, a framework, etc. with which to implement a data flow. In one embodiment the elements may be based on, derived from, and/or comply with a standard. The elements may work in conjunction with a standards-based implementation of a protocol.

In one embodiment application 211 generates a data flow. Application 211 may represent an executable series of instructions to produce/generate operations on client 200. Application 211, for example, may interface an external peripheral and/or external device, such as a Bluetooth microphone and/or headset, a wireless device, etc. A data flow may be of a particular type of traffic, for example, a QoS traffic flow that may be established with constraints on traffic control (e.g., bandwidth, delay, etc.). A profile may be preconfigured, e.g., a known or expected type of traffic, or the profile may be generated by the application and/or a user input. A preconfigured or preloaded profile may occur when an application stores a profile for a particular user function available on client 200. An application may be particular to video, for example, or to VoIP, and have a loaded profile for the particular traffic type. Application 211 may generate the data flow and pass associated data packets to other layers for operation. In one embodiment application 211 represents the top layer of a data stack.

Profile indicator 212 may represent a control layer corresponding to a data flow. Profile indicator 212 may provide/determine a profile as discussed above, and/or provide a determined profile to another element/module of client 200. In one embodiment profile indicator 212 may receive a profile from application 211, or obtain a profile indicated by application 211, or corresponding to by a traffic type indicated by application 211, and pass the profile and/or information/data relating to the profile to other layers in client 200. Profile indicator 212 may provide marking for data packets of a data flow, for example, marking a packet with a DSCP value, etc. Other profile parameters that profile indicator 212 may indicate to another element/module of client 200 include a coder/decoder (codec) to use on the data flow, whether to implement security and what type if security is desired (e.g., IP Security (IPSec)), a virtual private network (VPN) value, a roaming profile/feature, a data rate, etc. One or more of these parameters may be indicated/provided by application 211. Others may be part of a preconfigured profile stored for a traffic type. Profile indicator 212 may indicate one or more parameters and/or other data relating to a traffic flow to QoS API 210 and/or standard API 215.

Standard API 215 may refer to a generally known and/or used API in a computing environment. For example, when a communication link is requested, a socket API may be accessed to establish a link/connection. This may be a link for a wireless QoS traffic flow. QoS API 210 may represent a control block/module/agent to receive and/or manipulate profile parameters. In one embodiment QoS API 210 represents a mechanism application 211 may use to indicate the profile parameters to mapping module 220 for configuration of the parameters on the elements of client 200. User input 213 represents a feature that may exist in certain implementations, where a user may have access to an environment and/or application of client 200 to specify certain configurations, e.g., a codec, data rate, etc. QoS API 210 may obtain and/or receive a profile of how each QoS traffic flow is to be supported by one or more layers on a platform of client 200, a WLAN link with an AP, and/or a MAC layer at an AP and/or wired connection of an AP. QoS API 210 may allow administrative configuration of client 200, for example, to load default settings, to configure client 200 according to global/corporate/enterprise settings, etc. QoS API 210 may represent one or more features extending a communication protocol.

Transport 230 may indicate a transport protocol, e.g., transmission control protocol (TCP), user datagram protocol, Internet protocol (IP), Internet control message protocol (ICMP), simple network management protocol (SNMP), Telnet, file transfer protocol (FTP), hypertext transfer protocol (HTTP), etc. Security 240 may indicate whether a security measure, e.g., IPSec, Advanced Encryption Standard (AES), etc., may be used. Security 240, transport 230, standard API 215 and/or QoS API 210 may provide information to and/or receive information from mapping module 220, for example, a protocol, a security type, etc., for a data flow.

Mapping module 220 may determine based at least in part on one or more inputs from other modules what parameters to use for a particular data flow. Mapping module 220 may indicate one or more traffic control parameters to other layers to establish the data flow and/or implement the data flow. For example, mapping module 220 may indicate a network (e.g., IP) and/or packet markings (e.g., TOS/DSCP) to network 250. Mapping module 220 may indicate a subnet identifier/tag to subnet 260, for example, a VLAN (virtual local area network) identifier (ID), for example, through an IEEE 802.1D marking, or a VPN ID. Mapping module 220 may indicate whether the packets and/or headers will be compressed, 270.

In one embodiment mapping module 220 provides, either directly or indirectly, to MAC layer 280 one or more configuration parameters, authentication parameters, settings, states, etc. This may be accomplished, for example, via a simple hook provided by an operating kernel into the QoS implementation, or other pluggable kernel components, or dynamically loadable modules. In response to the configuration parameters, settings at MAC layer 280 may be altered to match the provided settings. In one embodiment MAC layer 280 includes both standards—based functionality and extended functionality that may operate in conjunction with standard functionality. The result may be that MAC layer 280 controls an interface to a wireless (e.g., WLAN) link 282 according to the settings. In one embodiment MAC layer 281 at access point 290 may support the same functionality as MAC layer 280 of client 200. If both MAC layers support extended functionality, traffic control may be more closely controlled for a traffic flow of client 200. This may result in a better QoS for the traffic flow. In another embodiment MAC layer 280 and MAC layer 281 may support different functionality, and the QoS at client 200 may still be improved over traditional best-efforts scheduling practices employed for priority data traffic.

Statistics 285 that may exist separately from MAC layer 280 and/or be a part of MAC layer 280 (represent functions that may be performed by MAC layer 280). Statistics 285 may provide/obtain information regarding one or more QoS parameters. The parameters may be monitored to determine that a QoS level is being achieved for a traffic flow, or determine that a QoS implementation is be properly applied. Statistics 285 may represent one or more functions for provide AP selection. For example, if operating statistics indicate that a particular AP cannot provide the resources indicated for a traffic flow, the communication space may be scanned for an alternative AP that may have available resources. Statistics 285 may represent data and/or an information gathering entity to provide data to perform access control. Statistics 285 may indicate that insufficient resources are available for providing an additional QoS traffic flow. Thus, if an additional QoS traffic flow request is made, it may be denied.

In one embodiment access point 290 may include an optional compression layer 271, which enables access point 290 to recognize and operate on compressed traffic, or traffic with compressed headers. Access point may also include higher layers 291, which may or may not be modified from standard definitions according to a communication protocol. In one embodiment MAC layer 281 and compression 271 of access point 290 may be modified to implement QoS on a data flow from client 200. In another embodiment other layers may also be modified in access point 290. Although not shown, access point 290 may include an interface to a wide area network (WAN) that may include landline devices.

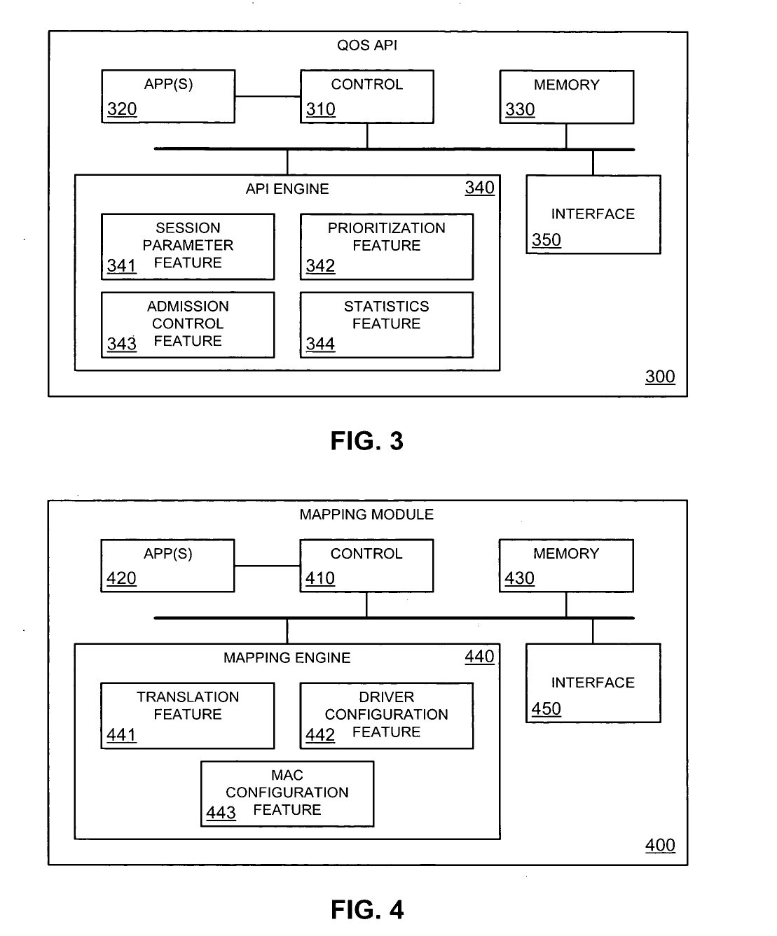

FIG. 3 is an embodiment of a block diagram of a QoS API. QoS API 300 represents a software module, a combination of logic, hardware, firmware and/or group/series/set of instructions for execution on a computation/logic device, a subsystem, or a virtual subsystem that is configured, enabled, or otherwise able to perform operations related to interfacing with a user application. Control logic 310 directs the flow of operation of QoS API 300. In one embodiment, control logic 310 may represent a series of software/firmware instructions to perform logic operations. In another embodiment, control logic 310 may be implemented by hardware control logic, or a combination of hardware-based control logic and software instructions. Hardware control logic may include discrete circuits, a processor, a microcontroller, a logic array, etc.

Interface 350 may provide a communication interface between QoS API 300 and a software module/program/application, a computing platform, an external electronic system (not shown), and/or network. For example, QoS API 300 may run on a computing platform on a computing system/device with interface 350 to provide a communication interface to resources on the computing system, for example, programs, software libraries, processors, etc.

Application(s) 320 represent one or more applications that may interact with QoS API 300. In one embodiment application 320 may represent an application running on QoS API 300. In another embodiment application 320 may represent one or more programs and/or other series of instruction sequences provided from outside QoS API 300, for example, over interface 350 to be executed on control logic 310. In one embodiment QoS API 300 may execute part of all of a user application or a system application. Application 320 may provide instructions to control logic 310 to cause or result in QoS API 300 performing an operation.

Instructions and/or data may also be provided to control logic 310 by memory 330. For example, control logic 310 may access, or read a portion of memory 330 to obtain instructions to perform a series of operations and/or data for use with operations. Thus, control logic 310 can receive one or more instructions from internal application software running locally associated with QoS API 300, such as application 320, from memory 330, and/or from an external application, storage medium, etc., through interface 350.

QoS API 300 includes API engine 340. In one embodiment API engine 340 may be considered an interface module. In one embodiment QoS API 300 may perform operations including determining profiles, associated profiles with a data flow/traffic stream, marking a data flow for a particular treatment (e.g., QoS) in a data path of the data flow, etc. API engine 340 is shown with various features, which represent functions or features that API engine 340 may provide. Each function or feature may be provided through performing one or more operations. API engine 340 may include one or more of: session parameter feature 341, prioritization feature 342, admission control feature 343, and statistics feature 344. In one embodiment one or more of these features may exist independently of and/or be external to QoS API 300. Thus, API engine 340 may be more complex or less complex, containing some, all, or additional features to those represented in FIG. 3.

Session parameter feature 341 may enable QoS API 300 to provide a characterization of and/or provide configuration for, traffic control of a traffic flow. Traffic control may include specifying procedures to be applied to a traffic flow, configurations settings with which to operate on a traffic flow, a state for a module or layer of a data flow path to be in for operating on a traffic flow, etc. In one embodiment session parameter includes a traffic profile, and/or data with which to generate/determine a traffic profile. A traffic profile may include a specification for establishing a traffic flow for a particular traffic type. The profile may include a reference to a specific codec, a VPN, a data rate, etc. In one embodiment session parameter feature 341 may include preloading a traffic profile, for example, storing a specification, a list of parameters, a set of configurations, etc., for use with traffic packets associated with the profile. In another embodiment session parameter feature 341 may include obtaining user input and/or user specifications as to configurations to use in handling the traffic flow.

Prioritization feature 342 may enable QoS API 300 to provide a priority level for a traffic class, a particular traffic flow, traffic stream, a data flow, etc. Prioritization feature 342 may operate on principles based on, similar to, or derived from those defined in the IEEE 802.11e standard. This may allow traffic to be prioritized at one of multiple levels, which may be used at one or more layers of the data path for scheduling and/or operation on associated data packets. Use and implementation of priorities in data traffic may be performed according to known methods.

Admission control feature 343 may enable QoS API 300 to offer specialized traffic control in intelligently managing the establishment of QoS flows. Coupling admission control feature 343 with prioritization feature 342 may enable a wireless device to provide a better QoS than a device that offers, for example, only prioritization. Admission control feature 343 may refer to an ability of API engine 340 to provide for conditions on generation of a traffic flow that will receive QoS treatment. For example, admission control feature 343 may refer to being able to determine a number of streams/flows at particular priority level/QoS levels/classes, determine whether a newly requested traffic flow may be granted QoS status, including determining whether system resources will support the traffic flow at a particular QoS status. Thus, the number of QoS flows allowed can be controlled to better control throughput in the device to preserve resources for established flows.

In one embodiment admission control feature 343 may refer to the ability of QoS API 300 accessing information from lower layers to determine whether a QoS data flow requested by an application may be supported. This may include indicating the determination to the application. Admission control feature 343 may include functions that are present at multiple different layers of a flow path and/or a control path for a traffic stream. This may include information gathering at a MAC layer and/or interaction with a MAC driver.

In one embodiment admission control includes AP selection parameters. AP selection parameters may include gathering/obtaining information from a network and/or from the AP to determine whether another AP could be used to provide higher QoS for a traffic stream. For example, an AP to which a client device having QoS API 300 is communicating may have more traffic and/or more restraints on bandwidth/resource allocation than another AP within communication of the client device. Admission control 343 may receive this information, for example, from lower layers in raw format, or indicators interpreting raw data to indicate the availability and potential desirability of interfacing through another AP. Admission control 343 may enable QoS API 300 to indicate this information to an application attempting to generate a traffic flow, and the application may in turn determine based on the information and/or execution of certain routines/code sequences to attempt to mark the traffic flow for the other AP.

Statistics feature 344 may enable QoS API 300 to gather and use statistics on traffic in a client device. Statistics feature 344 may be considered a statistics module, or may provide functions with which QoS API 300 may be considered to be a statistics module. Statistics feature 344 may refer to an ability to preserve and determine status of bandwidth and admission within a client device. Statistics feature 344 may thus provide advisory capability to indicate a busy network to a client user, to indicate a network (including WLAN) use to a client user, and/or provide management functions automatically based on information received. For example, in one embodiment statistics feature 344 operates in conjunction with admission control feature 343 or equivalent to provide automatic AP selection based on preconfigured criteria. The criteria may include network usage, estimated delay, etc. In one embodiment statistics feature 344 may include IEEE 802.1D functionality to provide VPN capability over a WLAN. Statistics feature 344 may keep track of various specified parameters to ensure that a data stream is receiving the QoS requested. Action may be initiated automatically by statistics feature 344 if the requested QoS is not achieved and/or the user may be notified.

QoS API 300 may be implemented with firmware, software, or a combination of firmware and software. QoS API 300 may be implemented in hardware and/or a combination of hardware and software and/or firmware. The software and/or firmware content may provide instructions to cause executing hardware to perform various operations, including some or all of the functions/features described above. Thus, QoS API 300 may represent a software module and/or a general computing element (e.g., a processor) or a specific computing element (e.g., dedicated logic) executing software/firmware. In one embodiment QoS API 300 may reside on or run under a computing platform of a wireless device and interface with an application on the computing platform. In one embodiment QoS API 300 may be separate from the platform and/or reside on a separate environment and interface with an application running/being executed on the platform. Additionally, QoS API 300 may interface with layers of a data flow that reside on and/or off the platform.

FIG. 4 is an embodiment of a block diagram of a mapping module. Mapping module 400 represents a software module, a combination of logic, hardware, firmware and/or group/series/set of instructions for execution on a computation/logic device, a subsystem, or a virtual subsystem that is configured, enabled, or otherwise able to perform operations related to interfacing with a user application. Control logic 410 directs the flow of operation of mapping module 400. In one embodiment, control logic 410 may represent a series of software/firmware instructions to perform logic operations. In another embodiment, control logic 410 may be implemented by hardware control logic, or a combination of hardware-based control logic and software instructions. Hardware control logic may include discrete circuits, a processor, a microcontroller, a logic array, etc.

Interface 450 may provide a communication interface between mapping module 400 and a software module/program/application, a computing platform, an external electronic system (not shown), and/or network. For example, mapping module 400 may run on a computing platform on a computing system/device with interface 450 to provide a communication interface to resources on the computing system, for example, programs, software libraries, processors, etc.

Application(s) 420 represent one or more applications that may interact with mapping module 400. In one embodiment application 420 may represent an application running on mapping module 400. In another embodiment application 420 may represent one or more programs and/or other series of instruction sequences provided from outside mapping module 400, for example, over interface 450 to be executed on control logic 410. In one embodiment mapping module 400 may execute part of all of a user application or a system application. Application 420 may provide instructions to control logic 410 to cause or result in mapping module 400 performing an operation.

Instructions and/or data may also be provided to control logic 410 by memory 430. For example, control logic 410 may access, or read a portion of memory 430 to obtain instructions to perform a series of operations and/or data for use with operations. Thus, control logic 410 can receive one or more instructions from internal application software running locally associated with mapping module 400, such as application 420, from memory 430, and/or from an external application, storage medium, etc., through interface 450.

Mapping module 400 includes mapping engine 440. Mapping engine 440 is shown with various features, which represent functions or features that mapping engine 440 may provide. Each function or feature may be provided through performing one or more operations. Mapping engine 440 may include one or more of: translation feature 441, driver configuration feature 442, and MAC configuration feature 443. In one embodiment one or more of these features may exist independently of and/or be external to mapping module 400. Thus, mapping engine 440 may be more complex or less complex, containing some, all, or additional features to those represented in FIG. 4.

Translation feature 441 may enable mapping module 400 to provide parameters, configuration settings, etc., corresponding to a profile indicated for a traffic stream. This may include the use of a table and/or memory location access and/or data structure access. In one embodiment translation feature 441 may include receiving the parameters themselves, and determining which of various data flow layers are implicated in the implementation of the parameters.

Driver configuration feature 442 may enable mapping module 400 to indicate one or more functions, settings, configurations to a driver. A driver may include not only a software module that directly controls hardware, but also other modules, linked libraries, etc., which prepare traffic packets for use by the hardware. Thus, driver configuration feature 442 may include the ability to indicate to a layer in a data flow path, whether hardware or software, a configuration and/or a manner in which particular data should be handled. This may include indicating a priority setting, indicating that a particular function should be performed (e.g., processing the data packets according to a security scheme or preparing the traffic according to a particular subnet, etc.), indicating the use of a particular data filter or queue, etc.

MAC configuration feature 443 may enable mapping module 400 to configure a MAC or other low-level layer in a data flow path. Configuring a MAC may refer to passing configuration parameters directly to the hardware elements, passing parameters to a hardware driver, and/or setting values/variable/memory locations that may be used or accessed by a hardware driver. In one embodiment MAC configuration feature 443 refers to modification/specification of parameters that may or may not be supported in a standard MAC definition, and are specified in an extension of a standard MAC definition.

In one embodiment mapping module 400 is implemented with firmware, software, or a combination of firmware and software. Mapping module 400 may be implemented in hardware and/or a combination of hardware and software and/or firmware. The software and/or firmware content may provide instructions to cause executing hardware to perform various operations, including some or all of the functions/features described above. Thus, mapping module 400 may represent a software module and/or a general computing element (e.g., a processor) or a specific computing element (e.g., dedicated logic) executing software/firmware. In one embodiment mapping module 400 may reside on or run under a computing platform of a wireless device and interface with an application on the computing platform. In one embodiment mapping module 400 may be separate from the platform and/or reside on a separate environment and interface with an application running/being executed on the platform. Additionally, mapping module 400 may interface with layers of a data flow that reside on and/or off the platform.

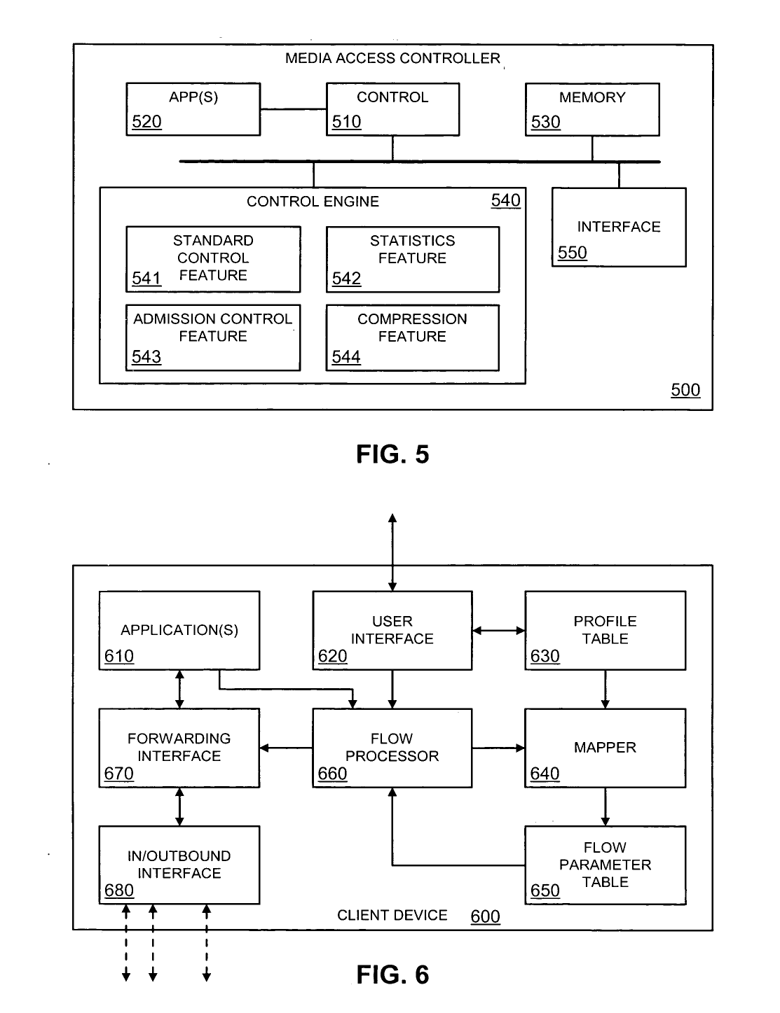

FIG. 5 is an embodiment of a block diagram of a media access controller (MAC). The MAC may provide control of a physical interface, e.g., a configuration/control of hardware of a wireless network card/circuit. Media access controller (MAC) 500 represents a software module, a combination of logic, hardware, firmware and/or group/series/set of instructions for execution on a computation/logic device, a subsystem, or a virtual subsystem that is configured, enabled, or otherwise able to perform operations related to interfacing with a user application. Control logic 510 directs the flow of operation of MAC 500. In one embodiment, control logic 510 may represent a series of software/firmware instructions to perform logic operations. In another embodiment, control logic 510 may be implemented by hardware control logic, or a combination of hardware-based control logic and software instructions. Hardware control logic may include discrete circuits, a processor, a microcontroller, a logic array, etc.

Interface 550 may provide a communication interface between MAC 500 and a software module/program/application, a computing platform, an external electronic system (not shown), and/or network. For example, MAC 500 may run on a computing platform on a computing system/device with interface 550 to provide a communication interface to resources on the computing system, for example, programs, software libraries, processors, etc.

Application(s) 520 represent one or more applications that may interact with MAC 500. In one embodiment application 520 may represent an application running on MAC 500. In another embodiment application 520 may represent one or more programs and/or other series of instruction sequences provided from outside MAC 500, for example, over interface 550 to be executed on control logic 510. In one embodiment MAC 500 may execute part of all of a user application or a system application. Application 520 may provide instructions to control logic 510 to cause or result in MAC 500 performing an operation.

Instructions and/or data may also be provided to control logic 510 by memory 530. For example, control logic 510 may access, or read a portion of memory 530 to obtain instructions to perform a series of operations and/or data for use with operations. Thus, control logic 510 can receive one or more instructions from internal application software running locally associated with MAC 500, such as application 520, from memory 530, and/or from an external application, storage medium, etc., through interface 550.

MAC 500 includes control engine 540. In one embodiment MAC 500 may perform operations including implementing configuration parameters, gathering and/or indicating statistics, establishing/maintaining wireless access links, etc. Control engine 540 is shown with various features, which represent functions or features that control engine 540 may provide. Each function or feature may be provided through performing one or more operations. Control engine 540 may include one or more of: standard control feature 541, statistics feature 542, admission control feature 543, and compression feature 544. In one embodiment one or more of these features may exist independently of and/or be external to MAC 500. Thus, control engine 540 may be more complex or less complex, containing some, all, or additional features to those represented in FIG. 5.

Standard control feature 541 may enable MAC 500 to provide standard features/functions specified by a particular communication protocol/specification. In one embodiment the functions traditionally available to MAC 500 through standard control feature 541 may be extended with additional features.

Statistics feature 542 may enable MAC 500 to obtain, including gathering, and use statistics on traffic for a client device. Statistics feature 542 may be considered a statistics module, or may provide functions with which MAC 500 may be considered to have a statistics module. Statistics feature 542 may refer to an ability to preserve and determine status of bandwidth and admission within a client device. In one embodiment statistics feature 344 operates in conjunction with admission control feature 543 or equivalent to provide automatic AP selection. Automatic AP selection may be based on preconfigured criteria, as well as gathered statistics. The criteria may include network usage, estimated delay, etc. Statistics feature 542 may provide the ability to keep and make determinations on raw statistical data, as well as passing statistical data and/or determinations derived from the data to other layers of a data flow path.

Admission control feature 543 may enable MAC 500 to offer specialized traffic control in intelligently managing the establishment of QoS flows. Admission control feature 543 may refer to an ability of control engine 540 to provide for conditions on generation of a traffic flow that will receive QoS treatment. For example, admission control feature 343 may refer to being able to determine a number of traffic streams/data flows at particular priority level/QoS levels/classes, determine whether a newly requested data flow may be granted QoS status, including determining whether system resources will support the data flow at a particular QoS status. With admission control feature 543, MAC 500 may be enabled to manage and provide for an appropriate QoS for each QoS flow.

In one embodiment admission control includes AP selection parameters. AP selection parameters may include gathering/obtaining information from a network and/or from the AP to determine whether another AP could be used to provide higher QoS for a traffic stream. For example, an AP to which a client device having MAC 500 is communicating may have more traffic and/or more restraints on bandwidth/resource allocation than another AP within communication of the client device. Admission control 543 may receive this information, for example, from lower layers in raw format, or indicators interpreting raw data to indicate the availability and potential desirability of another AP. Admission control 543 may enable MAC 500 to indicate this information to an application attempting to generate a traffic flow, and the application may in turn determine based on the information and/or execution of certain routines/code sequences to attempt to mark the traffic flow for the other AP.

Compression feature 544 may enable MAC 500 to detect and take appropriate action for compressed payloads. For example, a data packet/frame may be compressed for more efficient transfer of data. The wireless client and/or the AP may take advantage of the compression by recognizing compressed packet headers and appropriately allocating bandwidth for their transmission/reception. For example, compressing a payload may result in a 10% bit savings. Without compression feature 544, a client device may allocate the full amount of bandwidth for the payload, despite the fact that the payload is compressed. Compression feature 544 may enable MAC 500 to allocate 10% less bandwidth to represent the bit savings resulting from the compression of the payload.

In one embodiment MAC 500 is implemented with firmware, software, or a combination of firmware and software. MAC 500 may be implemented in hardware and/or a combination of hardware and software and/or firmware. The software and/or firmware content may provide instructions to cause executing hardware to perform various operations, including some or all of the functions/features described above. Thus, MAC 500 may represent a software module and/or a general computing element (e.g., a processor) or a specific computing element (e.g., dedicated logic) executing software/firmware. In one embodiment MAC 500 may reside on or run under a computing platform of a wireless device and interface with an application on the computing platform. In one embodiment MAC 500 may be separate from the platform and/or reside on a separate environment and interface with an application running/being executed on the platform. Additionally, MAC 500 may interface with layers of a data flow that reside on and/or off the platform.

Instructions that may cause/result in the performing of functions/operations of QoS API 300, mapping module 400, and/or MAC 500 may be received via an article of manufacture by a machine/electronic device/hardware and performed by/on the machine. An article of manufacture may include a machine accessible/readable medium having content to provide the instructions. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. The machine accessible medium may further include a computing system having code loaded on the computing system that the computing system may be able to execute when the computing system is in operation. Thus, delivering a computing system with such code may be understood as providing the article of manufacture with such content described above. Furthermore, storing code on a database or other memory location and offering the code for download over a communication medium via a propagated signal may be understood as providing the article of manufacture with such content described above.

FIG. 6 is an embodiment of a block diagram of a client device. Client device 600 may represent a client of a WLAN that communicates with a wireless AP, for example, a mobile station. Client device 600 may include one or more applications 610, which represents a software execution that may generate a data/traffic flow/stream. Application 610 may be communicatively coupled with flow processor 660 and forwarding interface 670.

In one embodiment client device 600 includes user interface 620, which may represent one or more mechanisms for interacting with a device user. For example, user interface may include a display element (e.g., a liquid crystal display (LCD), a graphical user interface (GUI), a touchscreen and/or graphical representation), an input mechanism (e.g., a button, a touchscreen, an audio input), etc. A user of client device 600 may provide a profile and/or elements/parameters of a profile through user interface 620.

Profile table 630 may include data in a storage/memory indicating parameter settings for one or more layers of the data flow path (a stack, a sequence of one or more operations/functions with which to evaluate/manipulate a data packet). Profile table 630 may indicate/pass a parameter or a profile to mapper 640, which may determine a class of traffic to which the data flow belongs, and may indicate the proper settings to other layers of the data flow path.

In one embodiment mapper 640 may receive input from flow processor 660, which may include information from application 610. Flow processor 660 may indicate statistics and/or determinations based on statistics from application 610 to mapper 640, which may make appropriate correction to one or more settings/parameters. Mapper 640 may provide input to flow parameter table 650, which may indicate the determined parameters to flow processor 660. In one embodiment flow parameter table 650 may represent a functional part of mapper 640 through which mapper 640 is able to translate a received profile into configuration settings. In one embodiment modifications to a traffic flow, or to a traffic class may be implicated in the a statistics report received by mapper 640 from flow processor 660, and mapper 640 modifies one or more entries in flow parameter table 650 accordingly.

Forwarding interface 670 may represent a mechanism or module (e.g., a logic entity, an API) that provides a data and/or control path for a traffic stream. In one embodiment, a data path may be considered to exist between application 610 where a stream is generated, forwarding interface 670 that operates on the data and forwards it to in/outbound interface 680. Thus, in one embodiment forwarding interface 670 represents one or more layers in a data flow path between an application layer (application 610) and a medium interface/driver (in/outbound interface 680). In/outbound interface 680 may include a MAC that provides one or more wireless links to one or more APs. In/outbound interface 680 may provide a return path through forwarding interface 670 to application 610 and/or flow processor 660.

In a similar manner, in one embodiment user interface 620, profile table 630, mapper 640, flow parameter table 650, and flow processor 660 may represent the control flow that provide traffic control functions for directing how the data flow path processes and/or passes a traffic flow to an external entity over a wireless link. Thus, flow processor 660 may represent an application function that provides the implementation of QoS parameters determined by use of a profile from profile table 630, and parameters determined by mapper 640 and flow parameter table 650. Flow processor may represent one or more functions of a mapping agent, which may include a mapping module and/or a QoS API, as described previously.

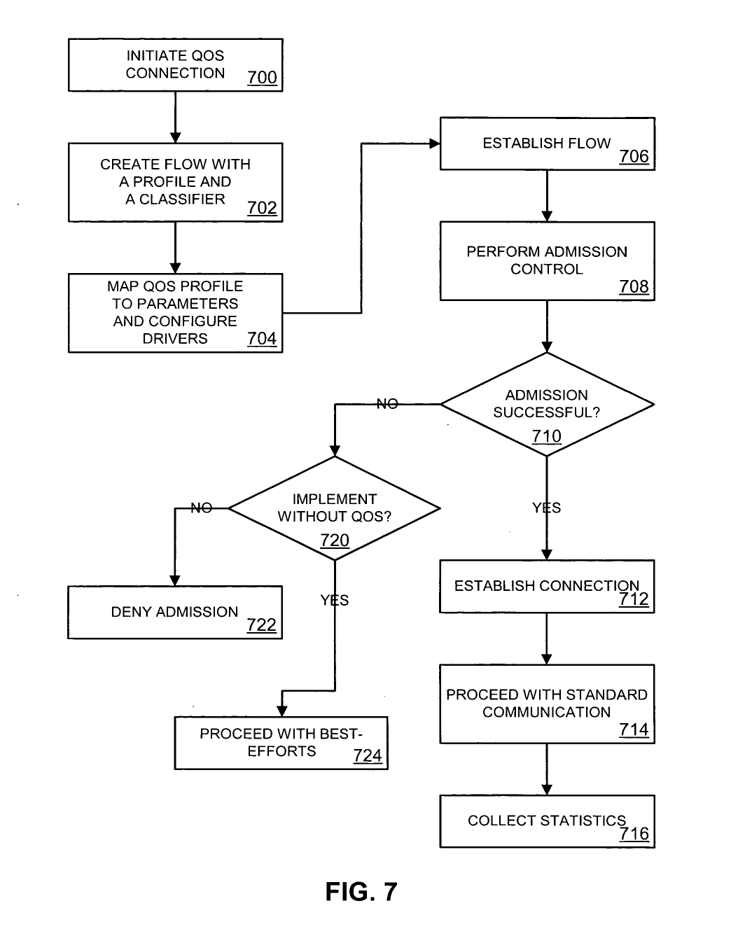

FIG. 7 is an embodiment of a flow diagram of establishing QoS traffic in a WLAN. A QoS connection is initiated, 700. For example, an application running on a device having wireless capability may attempt to establish a VoIP call or other QoS connection on a data connection over a WLAN of which the device is a part. In another embodiment an application on the device may attempt to transmit and/or receive a video stream over the WLAN.

The QoS connection may be initiated by creating a traffic flow. The traffic flow may be created with a profile and classifier, 702. These may be generated by the application generating the flow, may be specified in whole or in part by user input, and/or may be preconfigured on the device. The classifier may indicate a type of traffic to which the flow belongs, and may be a type of traffic the device is configured/set up to process/handle. A profile may be a QoS profile used to indicate one or more parameters associated with the traffic flow, and/or a QoS characteristic of the traffic flow. The parameters may represent constraints on the traffic flow, e.g., minimum bandwidth requirements, maximum delay tolerance, etc. The parameters may include other information related to handling the traffic flow, e.g., a DSCP value, a VPN address, etc. These parameters may be passed from the application to the various layers of the communication stack to handle the traffic flow via a QoS API.

The QoS profile may be mapped to specific parameters and drivers configured according to the parameters, 704. A mapping module may receive the QoS profile and determine what parameters to associate with the traffic flow. For example, a mapping module may receive the profile from a QoS API and determine via a table what parameters of the various layers will be best to ensure the QoS is satisfied for the traffic flow. The traffic flow may be established, 706. The flow may be established in conjunction with determining the parameters and configuring the various drivers and/or layers, or alternatively, once the configurations are implemented, the flow may be established. The flow may be considered to be established when resources are allocated at each layer of the communication stack to reserve a data path for the traffic flow.

To generate the connection of the data flow with an AP of the WLAN, admission of the flow may be performed, 708. Admission control may have multiple aspects. For example, admission control may include a determination made at the device (the WLAN client) of whether the resources of the client are sufficient to admit a traffic flow having the QoS specified by the parameters/profile. This may involve determining bandwidth available, processing resources available, etc., to operate the traffic flow. Admission control may include a determination of whether the WLAN may support the traffic flow with the QoS specified. This may include determining first if the AP with which the client is associated could support the traffic flow. For example, statistics obtained from the AP and/or gathered at a MAC layer of the client may be used to make this determination. Determining whether the WLAN supports the traffic flow may also next include determining if another AP within communication of the client device could support the traffic flow. Network statistics may be used in making this determination.

It is determined if admission is successful (both within the client and within the WLAN), 710. The MAC layer may be responsible for making this determination in one embodiment. Alternately, the MAC layer may pass information to an application layer module (for example, an API and/or the application that generated the traffic flow), which may make the determination. If admission is successful, the connection is established, 712. This may be accomplished according to known principles. The traffic flow may proceed on the established connection with standard communication mechanisms/techniques and/or communication according to the parameters configured in the data path, 714. The client device may continue to gather/obtain statistics, 716. This may be in addition to information that may be used in establishing the connection. The statistics may be used to ensure that the QoS of the traffic stream is supported on the connection.

If admission is not successful, it is determined whether to implement the traffic flow without the requested QoS, 720. An unsuccessful admission attempt may be indicated to a requesting application, which may then determine to proceed under different circumstances. For example, in one embodiment the application may determine (e.g., automatically and/or via user input) to proceed with best efforts scheduling of the traffic flow. This may result in a degraded traffic flow. In another example, a lower QoS may be available, which may be applied for by the application to be associated with the traffic flow. Thus, the traffic stream may proceed with a QoS, but lower than that initially requested. If the traffic flow is not to proceed without the QoS, the traffic flow may be denied admission, 722. In one embodiment the traffic flow may proceed under best efforts, 724.

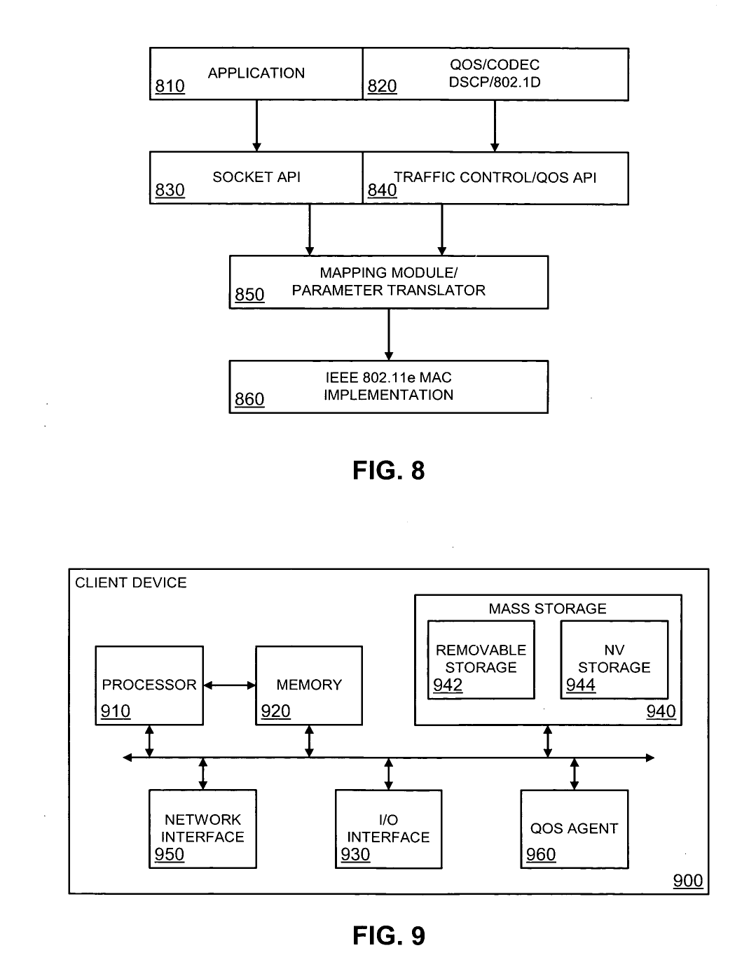

FIG. 8 is an embodiment of a block diagram of layers of a QoS data flow stack. Application 810 may be a software application being executed on an apparatus of a WLAN client. In one embodiment application 810 provides a user the ability to generate a QoS data flow, for example, a VoIP call. While a VoIP call is used as an example herein, the VoIP call is merely illustrative and is not to be understood as restricted. Other types of traffic, for example, video, multimedia, etc., may be dealt with in a similar manner as described herein. Various APIs, DLLs (dynamically linked libraries), subroutines, other applications, etc., may be accessible to application 810. For example, a QoS/codec 820 may represent one or more software entities, including a QoS API, a codec, or other program that may provide a profile for a VoIP call initiated by application 810. QoS/codec 820 may include the ability to mark a call according to DSCP and/or IEEE 802.1D.

In one embodiment application 810 may interface with socket API 830 to establish a data path for the call. Socket API 830 may represent a functional code mounted on an underlying operating system to provide access/control of communication port resources in the apparatus. QoS/codec 820 may in turn interface with traffic control API/QoS API 840. Traffic control API 840 may represent a module for control of the VoIP call, receiving and passing information from/to application 810. Note that data and control may have separate paths, with the VoIP call passing through socket API 830, and profiles and/or control parameters passing through traffic control API 840.

Socket API 830 and traffic control API 840 may interface with a mapping module 850, which may translate profiles and/or parameters into specific parameters and implement the parameters through configuring layers, modules, drivers, etc., that may have an effect on having the parameters successfully executed. Mapping module 850 may include inputs from both the data path and the control path, and merge/coordinate the operation of the two paths to provide a QoS to the VoIP call. The various parameters may affect one or more layers, and one or more of these layers may be specified in, for example, IEEE 802.11e. An IEEE 802.11e MAC implementation 860 may be affected by mapping module 850 to provide functionality extended beyond the functionality present in a traditional implementation.

FIG. 9 is an embodiment of a block diagram of a client device having a QoS agent. Client device 900 may include processor 910, which represents one or more processing units, including a central processing unit, a microcontroller, a digital signal processor (DSP), etc. Memory 920 may provide storage for temporary variables and/or instructions for execution by processor 910. Memory 920 may represent on-chip memory, for example, a cache layer on processor 910, or volatile storage on a system bus of client device 900. Memory 920 may be accessible directly by processor 910, accessible over a system bus, and/or a combination of these.

In one embodiment client device includes I/O (input/output) interface 930, which represents one or more mechanisms/devices through which client device 900 may receive input from an external source and/or provide output to an external source. An external source may include another computing system, a user, etc., and may include display devices, cursor controls, alphanumeric input devices, audio input and/or output devices, visual display (e.g., light emitting diodes (LEDs)), etc. I/O interface 930 may also include drivers for I/O devices. Information/data/instructions received through I/O interface 930 may be stored in memory 920 and/or mass storage 940. Mass storage 940 represents various storage mechanisms, including removable storage 942 (e.g., disk drives, memory sticks/cards/slots, universal serial bus (USB)—connected devices, etc.) and non-volatile storage 944 (e.g., disk drives, memory sticks/cards, slots, hard disk drives, etc.). Mass storage may store programs/application and/or instructions for loading into memory 920 for execution, and/or data relating to or associated with any of these. For example, mass storage 940 may include a program that provides QoS traffic control, and associated profile list/tables and instructions for the creation of such QoS traffic. Mass storage 940 may include mountable software modules for use by one or more programs, for example, APIs. Such modules may be mounted/loaded prior to loading/execution of a program with which the software module may interface.

In one embodiment client device may include network interface 950, which may include a wired or wireless interface and/or both wired and wireless interfaces. Network interface 950 may represent a network card/circuit through which client device 900 may interface with a wireless access point (WAP) in a WLAN. In one embodiment network interface 950 may be controlled by a MAC as part of a data flow path providing data packets from an application generating the packets to the hardware transmitting the packets, and/or the reverse.

In one embodiment client device 900 includes QoS agent 960, which may represent one or more components of traffic control to implement QoS. For example, QoS agent 960 may include a profiling mechanism for determining/generating a profile for a generated traffic flow, a mechanism for marking the traffic flow to indicate a parameter affecting how the traffic flow is treated/processed, a mechanism for interfacing between a traffic flow generating application and one or more other modules of a system architecture, a mechanism for generating configuration settings from the profile, and/or one or more mechanisms for implementing the configuration settings to provide the QoS to the traffic flow. QoS agent 960 may include elements for running these mechanisms and providing for their use. Such mechanisms and additional elements may comply with descriptions contained herein.

Besides what is described herein, various modifications may be made to embodiments of the invention without departing from their scope. Therefore, the illustrations and examples herein should be construed in an illustrative, and not a restrictive sense. The scope of the invention should be measured solely by reference to the claims that follow.

What is claimed is:

1. A method for communicating in a network, comprising:
generating a profile for a quality of service (QoS) data flow in a wireless network client;
generating a configuration parameter for achieving a QoS for the data flow in response to receiving the profile; and
configuring a layer of a data path associated with the data flow according to the configuration parameter to establish a QoS data path for the data flow.

2. A method according to claim 1, wherein the wireless network comprises a wireless local area network (WLAN).

3. A method according to claim 1, wherein the QoS data flow comprises one of a voice over Internet Protocol (VoIP) call, a multimedia stream, or a video stream.

4. A method according to claim 1, wherein generating the profile comprises creating a parameter list.

5. A method according to claim 1, wherein generating the profile comprises providing a index to a table entry.

6. A method according to claim 1, wherein generating the profile comprises indicating a class of traffic.

7. A method according to claim 1, wherein generating the profile comprises indicating one or more of a codec or a data rate.

8. A method according to claim 1, wherein generating the profile comprises indicating one or more of a delay bound, a roaming profile, a virtual private network parameter, or a device authentication parameter.

9. A method according to claim 1, wherein generating the configuration parameter comprises passing a parameter specified in the profile.

10. A method according to claim 1, wherein generating the configuration parameter comprises accessing a lookup table for a parameter.

11. A method according to claim 1, wherein configuring the layer of the data path comprises changing a setting of the data path layer.

12. A method according to claim 1, wherein configuring the layer of the data path comprises reserving a resource in the layer to provide the QoS for the data flow.

13. An article of manufacture comprising a machine accessible medium having content to provide instructions to result in a machine performing operations including:
generating a quality of service (QoS) profile for a traffic stream generated by a user application in a wireless local area network (WLAN) device;
generating a configuration setting for achieving a QoS for the traffic stream in a layer of a data path of the traffic stream in response to receiving the profile; and
configuring a layer of a data path associated with the traffic stream according to the configuration setting to establish a data path having the QoS for the traffic stream.

14. Article of manufacture according to claim 13, wherein the traffic stream comprises one or more of a voice over Internet Protocol (VoIP) call, a multimedia stream, or a video stream.

15. An article of manufacture according to claim 13, wherein the content to provide instructions to result in the machine generating the profile comprises the content to provide instructions to result in the machine indicating a traffic class to which the traffic stream belongs.

16. An article of manufacture according to claim 13, wherein the content to provide instructions to result in the machine generating the profile comprises the content to provide instructions to result in the machine indicating one or more of a codec, a data rate, or a security parameter.

17. An article of manufacture according to claim 13, wherein the content to provide instructions to result in the machine generating the configuration parameter comprises the content to provide instructions to result in the machine accessing a lookup table for a parameter.

18. An article of manufacture according to claim 13, wherein the content to provide instructions to result in the machine configuring the layer of the data path comprises the content to provide instructions to result in the machine allocating bandwidth at the layer to provide the QoS for the traffic stream.

19. An apparatus for communicating in a network, comprising:
a memory in a wireless local area network (WLAN) client having a communication architecture including
a control signal path having an application program interface (API) to interface with an application to indicate a profile for a quality of service (QoS) data flow and a mapping module coupled with the API to generate a configuration state from the profile for a data path of the data flow; and
a data path coupled with the control signal path having layers of a communication protocol, the data path to receive and apply the configuration state generated by the mapping module to establish the data flow in the data path with a QoS indicated for the data flow; and
a processor coupled to the memory to operate on the elements of the communication architecture.

20. An apparatus according to claim 19, wherein the profile comprises one or more of an indication of a class of traffic, a codec, a data rate, a jitter tolerance, or a roaming profile.

21. An apparatus according to claim 19, wherein the profile comprises a pre-configured parameter list.

22. An apparatus according to claim 19, wherein the communication protocol comprises a subsection of the International Electrical Engineer, IEEE 802 specification.

23. An apparatus according to claim 19, the data path further comprising a medium access controller (MAC) having extended functionality beyond the communication protocol, the MAC to control a wireless communication link with an access point (AP) according to the configuration state.

24. An apparatus according to claim 23, the MAC further comprising a statistics module to monitor QoS parameters of the data flow at the MAC.

25. An apparatus according to claim 24, the MAC further comprising an AP selection module to determine based, at least in part on the statistics, whether the AP supports the QoS of the data flow.

26. An apparatus according to claim 25, the AP selection module to further determine that the AP fails to support the QoS of the data flow, and that a different AP supports the QoS of the data flow.

27. An apparatus for communicating in a network, comprising:
a memory having a datastructure including
an application program interface (API) mounted on an operating system of a wireless device to interface with an application to indicate a profile for a quality of service (QoS) traffic flow generated by the application;
a logical layer of a communication protocol to establish the QoS traffic flow for packets associated with the application; and
a mapping module hooked into the operating system to interface with the API to translate the profile into a parameter of a communication protocol configure the logical layer to apply the parameter to handle the QoS traffic flow;
a processor coupled to execute operations associated with the datastructure; and
a non-volatile storage coupled with the processor to store the profile.

28. An apparatus according to claim 27, wherein the QoS traffic flow comprises a voice over Internet Protocol (VoIP) call.

29. An apparatus according to claim 27, wherein the profile comprises one or more of an indication of a class of traffic, a codec, a data rate, a jitter tolerance, or a roaming profile.

30. An apparatus according to claim 27, the non-volatile storage to store a user-defined profile to apply with the application.

31. An apparatus according to claim 27, the non-volatile storage to store a preconfigured profile defined as a standard profile in the application.

32. An apparatus according to claim 27, wherein the logical layer comprises a medium access controller (MAC) layer having functionality extending beyond the communication protocol specification, the MAC to control a wireless communication link with an access point (AP) according to the configuration state.

33. An apparatus according to claim 32, the MAC further comprising an AP selection module to determine one of multiple access points (APs) with which to establish a communication link, based at least in part on whether the AP has resources to support the QoS traffic flow.

34. A method in a wireless user device, comprising:
receiving a traffic profile corresponding to a traffic stream generated by a quality of service (QoS) application in a wireless device, the traffic profile received from a QoS application program interface (API) interfacing the QoS application, the QoS application requesting a QoS level for the traffic stream;
determining a configuration setting to apply to a layer of a data stack in the wireless device to achieve the QoS level for the traffic stream, the data stack to provide a data path for the traffic stream from the application to a physical wireless communication interface; and
applying the configuration setting to the layer of the data stack to establish a data path having the requested QoS level.

35. A method according to claim 34, wherein the QoS application comprises a voice over Internet Protocol (VoIP) application.

36. A method according to claim 34, wherein the layer of the data stack comprises a medium access layer.

37. A method according to claim 34, wherein the layer of the data stack comprises one or more of a subnet controller, a security layer, a network layer, or a compression layer.

38. An article of manufacture comprising a machine accessible medium having content to provide instructions to result in a machine performing operations including: method in a wireless local area network (WLAN) user device, comprising:
receiving a traffic profile corresponding to a traffic stream generated by a quality of service (QoS) application in a wireless device, the traffic profile received from a QoS application program interface (API) interfacing the QoS application in a wireless local area network (WLAN) user device, the QoS application requesting a QoS level for the traffic stream;
determining a configuration setting to apply to a layer of a data stack in the wireless device to achieve the QoS level for the traffic stream, the data stack to provide a data path for the traffic stream from the application to a physical wireless communication interface; and
applying the configuration setting to the layer of the data stack to establish a data path having the requested QoS level.

39. An article of manufacture according to claim 38, wherein the QoS application comprises one or more of a voice over Internet Protocol (VoIP) application or a multimedia application.

40. An article of manufacture according to claim 38, wherein the layer of the data stack comprises a medium access layer.

41. An article of manufacture according to claim 38, wherein the layer of the data stack comprises one or more of a subnet controller, a security layer, a network layer, or a compression layer.
